(19) United States
(12) Patent Application Publication
(10) Pub. No.: US 2022/0048068 A1
(43) Pub. Date: Feb. 17, 2022

(54) METHOD FOR PRODUCING AN ENDLESS BELT WITH A BELT BODY

(71) Applicant: Berndorf Innovations und Technologie GmbH, Berndorf (AT)

(72) Inventors: Markus HAYDN, Guntramsdorf (AT); Thomas STÜCKLER, Ternitz (AT); Pelin SÜALP, Wien (AT); Richard SZIGETHI, Neudörfl (AT)

(21) Appl. No.: 17/452,693

(22) Filed: Oct. 28, 2021

Related U.S. Application Data
(63) Continuation of application No. PCT/AT2020/060173, filed on Apr. 28, 2020.

(30) Foreign Application Priority Data
Apr. 29, 2019 (AT) A50391/2019

(51) Int. Cl. B05D 1/40; C09D 7/61

(52) U.S. Cl. CPC B05D 1/40; C09D 7/61

(57) ABSTRACT

A method for producing an endless belt, and an endless belt having a belt body with a first main surface and a second main surface connected to one another via lateral edges, wherein a coating is applied to the first main surface of the belt body being opposite to an inner side of the endless belt in a finished state of the endless belt, wherein the coating forms an outer side of the endless belt, wherein, as coating to the first main surface of the belt body, a matrix is applied which consists of at least one base material, with hard particles, in particular with a hardness measured according to Vickers of more than 500 [HV], preferably with a hardness between 1400 [HV] and 10060 [HV], being embedded into the matrix, wherein the coating is preferably applied directly to the first main surface of the belt body.

This application is a bypass continuation of, and claims priority under 35 U.S.C. §§ 120 and 365(c) from, International Application No. PCT/AT2020/060173, filed Apr. 28, 2020, designating the United States, which claims priority to Austrian Patent Application No. A50391/2019, filed Apr. 29, 2019, both of which are incorporated by reference herein.

The present disclosure relates to endless belts and to methods for producing an endless belt.

Belts for vehicle test rigs, wind tunnels and the like often have surface coverings and/or coatings that can tend to crack under continuous load, as these are often adhesive films. Furthermore, the known coatings do not adequately reflect actual road conditions, which is a disadvantage especially with regard to tests in vehicle test rigs and wind tunnels. Relevant methods and/or endless belts became known from WO2016123645A1 as well as JP2009069122A.

The inventors have identified opportunities to overcome the shortcomings of the known solutions and to provide an endless belt for the use in vehicle test rigs and wind tunnels, which has a mechanically very hard-wearing coating that does not detach from the endless belt even under continuous loads and which at the same time represents real road conditions well. Coatings according to the present disclosure may be prevented from detaching even in case of very small bending radii of the endless belt.

In accordance with one embodiment, on the one hand, a coating with an average roughness, in particular an average roughness depth, and/or an average surface finish and/or structure can be achieved, which corresponds to an average road coating and/or at least a coating can be realized, which approaches a road coating optically and/or with regard to the skid resistance, on the other hand, the coating can be applied directly to the surface of the belt body and very good adhesion can be achieved. In some embodiments, the coating can be applied directly to the surface of the belt body and very good adhesion between the coating and belt body can be achieved without the need for an additional adhesion promoter layer. Moreover, the applied coating fulfills a protective function for the belt body, in particular regarding impulse, strike and shear forces as well as against corrosion.

It was found to be particularly advantageous with regard to an optimum adhesion to the surface of the belt body if the base material forming the matrix for the hard particles is made of at least one polymer or a mixture of polymers, in particular selected from the group of polyimide (PI), polypropylene (PP), monoaxially oriented polypropylene (MOPP), biaxially oriented polypropylene (BOPP), polyethylene (PE), polyphenylene sulfide (PPS), polyetheretherketone (PEEK) polyetherketone (PEK), polyethyleneimide (PEI), polysulfone (PSU), Polyaryletherketone (PAEK), Polyethylene naphthalate (PEN), Liquid crystalline polymers (LCP), Polyester, Polybutylene terephthalate (PBT), Polyethylene terephthalate (PET), Polyamide (PA), Polycarbonate (PC), Cycloolefin copolymers (COC), Polyoxymethylene (POM), Acrylonitrile-butadiene-styrene (ABS), polyvinyl carbonate (PVC), ethylene tetrafluoroethylene (ETFE), polytetrafluoroethylene (PTFE), polyvinyl fluoride (PVF), polyvinylidene fluoride (PVDF) and/or ethylene-tetrafluoroethylene-hexafluoropropylene-fluoropolymer (EFEP), preferably a thermoplastic polymer. The base material forming the matrix for the hard particles may be solvent-based, for example, a hydrocarbon mixture may be used as the solvent. It is particularly advantageous if the matrix ensures sufficient flexibility compared to the belt material, as is ensured by many plastic materials, especially thermoplastics. Due to the manufacturing process, the matrix may also contain other substances, whereby after evaporation of the solvent the predominant part of the matrix consists of polymers.

Preferably organic particles, in particular wheat grit, particles from nut shells, rice or particles from broken cherry stones, and/or inorganic particles, in particular selected from the group, corundum (Al2O3), ruby, sapphire, quartz (SiO2), topaz (Al2[(F,OH)2|SiO4]), silicon carbide (SiC), diamond (C), boron nitride (BN), aggregated diamond nanorods (ADNR), ZrO2 and any possible dopants of ZrO2, in particular 8YSZ and 3 YSZ, sand, TiO2, metal or ceramic powders and inorganic agglomerates, may be used as hard particles.

In order to achieve a high mechanical load capacity of the endless belt, the belt body may be made of metal, wherein the belt body is closed, in particular by welding, to form an endless ring before the coating is applied. In this regard, the belt body of the endless belt may be made of a sheet metal, the end edges of which are welded together such that a closed ring is formed. However, the belt body may also be made of a sheet metal, the longitudinal edges of which are arranged helically and have a helical longitudinal weld seam, as became known for example from U.S. Pat. No. 3,728,066A. Alternatively to the use of merely one single sheet metal for producing the belt body, multiple sheet metals welded together may be used as well. Thus, the belt body may be formed of two or multiple sheet metals, the longitudinal edges and end edges of which are welded together, such that a closed ring with a desired width and length may be produced, as became known for example from AT514722B1. Alternatively, the endless belt may also be made of a plastic material or a fiber-like material, such as carbon fibers.

The application of the coating onto the endless belt is simplified by the belt bode closed to an endless ring being circumferentially arranged between two rollers before the application of the coating.

The base material may, preferably together with the hard particles, be applied to the belt surface for example by spraying, rolling, trowelling, brushing and similar methods.

Preferably, the base material and the hard particles are applied to an upper run of the belt body formed into a closed ring and distributed uniformly on the upper run by means of the doctor blade, wherein the belt body is moved further in a circumferential direction during or after the distribution of the base material and the hard particles. The upper run of the endless belt comprises an upper section of the endless belt located between the two deflection rollers as well as an upper section of the endless belt resting on the deflection rollers. The lower part of the endless belt opposite the upper run is referred to as lower run.

A variant in which the hard particles are mixed into the base material forming the matrix for the hard particles before the application to the first main surface of the belt body has proved to be particularly advantageous with regard to the efficiency of the application of the coating.

Hard particles with a particle size between 0.01 and 3 mm preferably between 0.05 to 2 mm, particularly preferred between 0.1 to 1 mm, have proven to be particularly suitable. The values given here represent an average value of the particle size.

In a preferred embodiment, it is provided that the base material forming the matrix for the hard particles is made of at least one polymer or a mixture of polymers, in particular selected from the group of polyimide (PI), polypropylene (PP), monoaxially oriented polypropylene (MOPP), biaxially oriented polypropylene (BOPP), polyethylene (PE), polyphenylene sulfide (PPS), polyetheretherketone (PEEK) polyetherketone (PEK), polyethyleneimide (PEI), polysulfone (PSU), Polyaryletherketone (PAEK), Polyethylene naphthalate (PEN), Liquid crystalline polymers (LCP), Polyester, Polybutylene terephthalate (PBT), Polyethylene terephthalate (PET), Polyamide (PA), Polycarbonate (PC), Cycloolefin copolymers (COC), Polyoxymethylene (POM), Acrylonitrile-butadiene-styrene (ABS), polyvinyl carbonate (PVC), ethylene tetrafluoroethylene (ETFE), polytetrafluoroethylene (PTFE), polyvinyl fluoride (PVF), polyvinylidene fluoride (PVDF) and/or ethylene-tetrafluoroethylene-hexafluoropropylene-fluoropolymer (EFEP), preferably a thermoplastic polymer.

A variant, in which the hard particles are organic particles, in particular wheat grit, particles from nut shells, rice or particles from broken cherry stones, and/or inorganic particles, in particular selected from the group, corundum (Al2O3), ruby, sapphire, quartz (SiO2), topaz (Al2[(F,OH)2|SiO4]), silicon carbide (SiC), diamond (C), boron nitride (BN), aggregated diamond nanorods (ADNR), ZrO2 and any possible dopants of ZrO2, in particular 8YSZ and 3 YSZ, sand, TiO2, metal or ceramic powders and inorganic agglomerates, has proven particularly advantageous.

Preferably, the hard particles have a grain size of between 0.01 and 3 mm, preferably between 0.05 to 2 mm, particularly preferred between 0.1 and 1 mm.

Moreover, it has proven to be particularly advantageous if a surface of the coating comprises 1 to 10000, preferably 1 to 1000, particularly preferred 10 to 1000, hard particles per cm².

In an embodiment which is particularly well suited for applications in vehicle test rigs, wind tunnels and the like, the coating has a slip resistance of R13 according to DIN-51130 in a dry and in a wet surface condition.

A high mechanical load-bearing capacity of the endless belt may be achieved by the belt body being made of metal, in particular steel.

It has proven particularly advantageous in terms of adhesion to the belt body and realization of a good simulation of road conditions for the coating to have a layer thickness of between 0.1 and 5 mm, in particular between 0.5 and 1.5 mm.

Moreover, it has proven to be advantageous if the coating has an average roughness depth of more than 100 μm, preferably of more than 300 μm, particularly preferred of more than 500 μm.

In an embodiment which is particularly suitable for the use as a wheel drive belt in vehicle test rigs or in wind tunnels and the like, it is provided that the endless belt has a circumferential length of between 0.2 m and 30 m, in particular between 1 m and 25 m and a thickness of between 0.1 mm and 4 mm, in particular between 0.2 mm and 1.2 mm and a width of between 0.1 m and 10 m, in particular between 0.2 m and 3.2 m.

The permanent load-bearing capacity of the coating can be substantially increased by the coating being seamless. In this variant, the coating has no discernible start and end points, as would be the case, for example, if a film were used, but instead merges into itself without any discontinuity points.

For the purpose of better understanding of the invention, it will be elucidated in more detail by means of the figures below.

These show in a respectively very simplified schematic representation:

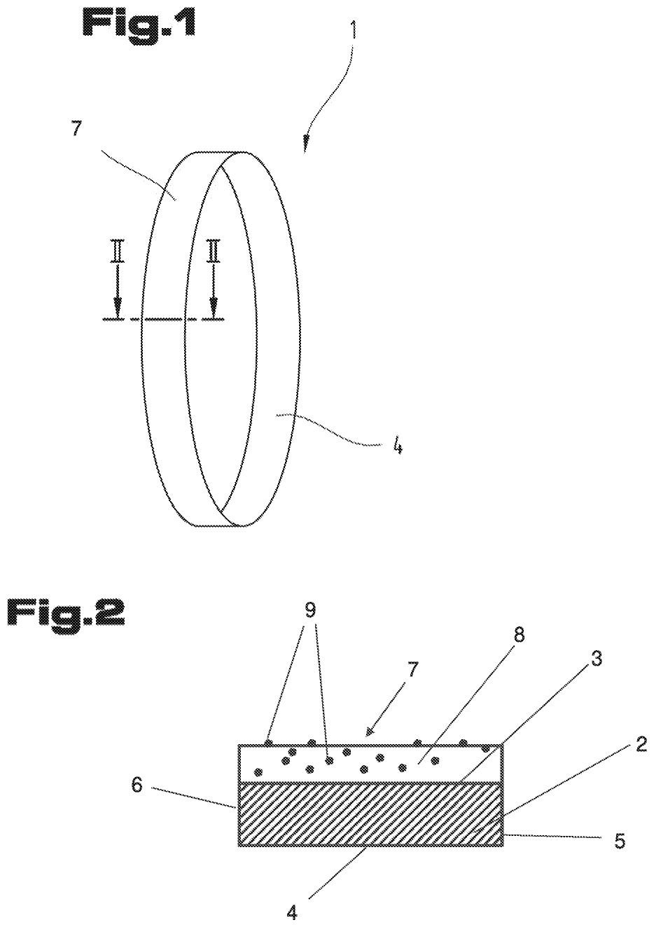

FIG. 1 a perspective view of an endless belt according to an embodiment;

FIG. 2 a section along the line II-II in FIG. 1, and

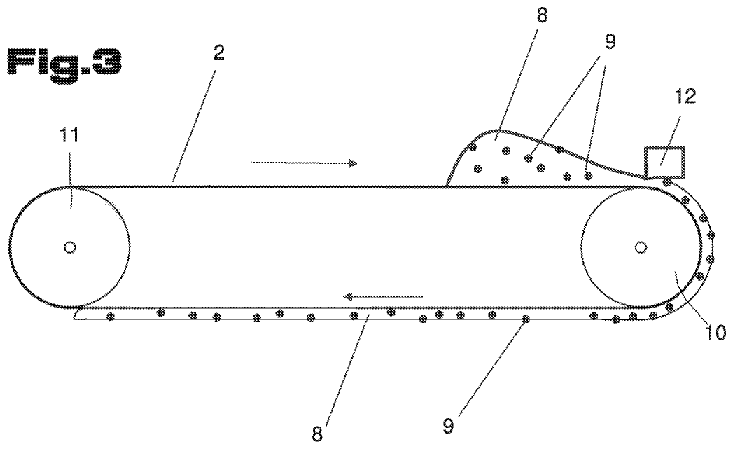

FIG. 3 a depiction of the production process according to an embodiment.

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

All indications regarding ranges of values in the present description are to be understood such that these also comprise random and all partial ranges from it, for example, the indication 1 to 10 is to be understood such that it comprises all partial ranges based on the lower limit 1 and the upper limit 10, i.e. all partial ranges start with a lower limit of 1 or larger and end with an upper limit of 10 or less, for example 1 through 1.7, or 3.2 through 8.1, or 5.5 through 10.

In addition, it should be noted that the embodiments are described across figures.

According to FIGS. 1 and 2, an endless belt 1 comprises a belt body 2 having a first main surface 3 and a second main surface 4. The first main surface 3 and the second main surface 4 of the belt body 2 are connected to each other via lateral edges 5, 6. The inner side of the endless belt 1 may be formed by the second main surface 4. A coating 7 is applied to the main surface 3 of the belt body 2 opposite the inner side of the endless belt 1.

The coating 7 forms an outer surface of the endless belt 1 and has a matrix consisting of a base material 8 into which hard particles 9 are embedded. The hard particles 9 are made of a material which can have a hardness measured according to Vickers of more than 500 [HV], in particular a hardness between 1400 [HV] and 10060 [HV]. The Vickers hardness values given in this document refer to a Vickers hardness test with a test force ≥49.03 N, in particular 49.03 N. In other words, the hard particles are made of a material that preferably has a Mohs hardness of above 5, in particular between 6 and 10. In this regard, the indication in Mohs hardness represents an alternative to the indication in Vickers hardness.

According to a preferred variant, the coating 7 is applied directly to the first main surface 3 of the belt body 2. The belt body 2 is preferably made of metal, in particular of steel.

The coating 7 may, for example, have a layer thickness of between 0.2 and 2 mm, in particular of between 0.5 and 1.5 mm, and an average roughness depth of more than 100 μm, preferably of more than 300 μm, particularly preferred of more than 500 μm. Moreover, the coating 7 may be designed to be seamless and essentially homogeneous.

The endless belt 1 may have a circumferential length of between 0.2 m and 30 m, in particular between 1 m and 25 m, and a thickness of between 0.1 mm and 4 mm, in particular between 0.2 mm and 1.2 mm, and a width of between 0.1 m and 10 m, in particular between 0.2 m and 3.2 m.

The base material 8 forming the matrix for the hard particles 9 may be formed of a polymer or a mixture of polymers. Preferably, the polymer or polymer mixture used is selected from the group of polyimide (PI), polypropylene (PP), monoaxially oriented polypropylene (MOPP), biaxially oriented polypropylene (BOPP), polyethylene (PE), polyphenylene sulfide (PPS), polyetheretherketone (PEEK) polyetherketone (PEK), polyethyleneimide (PEI), polysulfone (PSU), polyaryletherketone (PAEK), polyethylene naphthalate (PEN), liquid crystalline polymers (LCP), polyester, polybutylene terephthalate (PBT), polyethylene terephthalate (PET), polyamide (PA), polycarbonate (PC), cycloolefin copolymers (COC), polyoxymethylene (POM), acrylonitrile-butadiene-styrene (ABS), polyvinyl carbonate (PVC) ethylene tetrafluoroethylene (ETFE), polytetrafluoroethylene (PTFE), polyvinyl fluoride (PVF), polyvinylidene fluoride (PVDF) and/or ethylene-tetrafluoroethylene-hexafluoropropylene-fluoropolymer (EFEP). It is particularly preferred for the base material 8 to be formed from a thermoplastic polymer, wherein, however thermoset or elastomeric polymers can in principle also be used to realize the matrix formed from the base material 8.

The hard particles 9 may be formed by organic particles, in particular wheat grit, particles from nut shells, rice or particles from broken cherry stones, and/or inorganic particles, in particular selected from the group, corundum (Al2O3), ruby, sapphire, quartz (SiO2), topaz (Al2[(F,OH)2|SiO4]), silicon carbide (SiC), diamond (C), boron nitride (BN), aggregated diamond nanorods (ADNR), ZrO2 and any possible dopants of ZrO2, in particular 8YSZ and 3 YSZ, sand, TiO2, metal or ceramic powders and inorganic agglomerates.

A medium grain size of the hard particles 9 preferably amounts to between 0.01 and 3 mm, preferably between 0.05 to 2 mm, particularly preferred between 0.1 and 1 mm. The hard particles 9 may be present as single particles or, as is often the case for finer grain sizes, in the form of agglomerates. The individual particles may be similar and have a regular geometric shape—for example spherical or cylindrical. However, the individual particles may also have an irregular shape and no similarities. An example of this is the production of powders by crushing and grinding, as is frequently used for ceramic particles. Powders produced in this way have a wide particle size distribution which is statistically distributed, the d50 parameter being used as the mean value of the particle size. The mean diameter d50 of such hard particles 9 is between 0.01 to 3 mm, preferably between 0.05 to 2 mm, and particularly preferred between 0.1 to 1 mm. A surface of the coating 7 may have, for example, 1 to 10000, preferably 1 to 1000, particularly preferred 10 to 1000, hard particles per cm². In a dry and in a wet surface state, the coating 7 preferably has a slip resistance of R13 according to DIN-51130.

To produce the endless belt 1 according to one embodiment, the base material 8 is applied directly to the first main surface 3 of the belt body 2 according to FIG. 3. In this case, the base material 8 can be applied to the first main surface 3 of the belt body 2 in a liquid form, in particular in a viscous form, preferably in a viscous form with a dynamic viscosity of 10²-10⁵ mPas, in particular 10⁴-10⁵ mPas.

According to a preferred variant of the method, the hard particles 9 are already mixed into the base material 8 before an application of the base material 8 to the belt body 2. Alternatively, however, the base material 8 can first be applied to the belt body 2 and then the hard particles 9 can be distributed in the already applied base material 8. For example, the hard particles 9 can be scattered over the still wet base material 8. The hard particles 9 may be statistically distributed in the matrix formed from the base material 8.

The base material 8 and the hard particles 9 can be distributed evenly on the first main surface 3 of the belt body 2 by means of a doctor blade 12, for example by means of a strip-shaped doctor blade.

Alternatively or in addition to the use of a doctor blade, the base material 8 and the hard particles 9 can also be applied and distributed on the surface of the belt body 2 by rolling, trowelling, brushing, extruding or spraying. Coating of the belt body 2 with the base material 8 and the hard particles 9 by means of a curtain coating process is also possible.

As can be seen from FIG. 3, the belt body 2 may be closed to form an endless ring before the coating 7 is applied. If the belt body 2 is made of metal, it can preferably be closed to form the ring by welding, although other types of connection such as riveting would also be possible in principle. The belt body 2 closed to form an endless ring may be circumferentially arranged between two rollers 10, 11 before the coating 7 is applied.

The base material 8 and the hard particles 9 may be applied to an upper run of the belt body 2 formed into a closed ring and distributed evenly on the upper run, for example, by means of the doctor blade 12. The belt body 2 can be moved further in a circumferential direction during or after the distribution of the base material 8 and the hard particles 9. After the base material 8 has dried, the hard particles 9 are firmly embedded in it and the coating 7 formed from the dried base material 8 and the hard particles 9 is inseparably bonded to the first main surface 3 of the belt body 2 of the endless belt 1.

The coating 7 may be applied to the closed belt body 2 in a single web, or it may be applied in multiple webs. There may be a non-coated gap between the webs. Preferably, the belt body 2 is not coated all the way to the edge to allow control of the belt movement with a belt edge sensor. In the case of multiple webs, these may have different widths. However, the webs may also have different coatings 7 with regard to the composition of the matrix and the hard particles 9.

If necessary, a subsequent treatment could still be carried out in the wet or also in the dry state of the coating 7, for example by grinding, scratching, smoothing, polishing, skin pass, texturing. In particular, when a thermoplastic material 8 is used as the base material for the matrix, a subsequent heat treatment may be carried out to modify the surface after the coating 7 has dried. Such a heat treatment may include the entire surface such that the coating properties are globally changed—for example, the texture, homogeneity or residual stresses, etc. of the coating 7 may be changed. If required, heat input can also be applied only locally in order to introduce possible local structuring, particularly in the case of a thermoplastic matrix.

In particular, it is also possible to apply the coating 7 in multiple layers and/or to retouch it locally.

Finally, as a matter of form, it should be noted that for ease of understanding of the structure, elements are partially not depicted to scale and/or are enlarged and/or are reduced in size.

The invention claimed is:

1. A method for producing an endless belt having a belt body having a first main surface and a second main surface, wherein the first main surface and the second main surface of the belt body are connected to one another via lateral edges, wherein a coating is applied to the first main surface of the belt body being opposite to an inner side of the endless belt in a finished state of the endless belt, wherein the coating forms an outer side of the endless belt in a finished state, the method comprising:
applying a matrix as the coating to the first main surface of the belt body, the matrix consisting of at least one base material with hard particles of at least one material with a hardness measured according to Vickers of between 1400 [HV] and 10060 [HV] being embedded and/or having been embedded into the base material, wherein the coating is preferably applied directly to the first main surface of the belt body, and wherein the base material is applied in a liquid in viscous form with a dynamic viscosity of 10²-10⁵mPas together with the hard particles, to the first main surface of the belt body and is distributed uniformly on the first main surface of the belt body by means of a doctor blade.

2. The method according to claim 1, characterized in that the base material forming the matrix for the hard particles is made of at least one polymer or a mixture of polymers selected from the group of polyimide (PI), polypropylene (PP), monoaxially oriented polypropylene (MOPP), biaxially oriented polypropylene (BOPP), polyethylene (PE), polyphenylene sulfide (PPS), polyetheretherketone (PEEK) polyetherketone (PEK), polyethyleneimide (PEI), polysulfone (PSU), Polyaryletherketone (PAEK), Polyethylene naphthalate (PEN), Liquid crystalline polymers (LCP), Polyester, Polybutylene terephthalate (PBT), Polyethylene terephthalate (PET), Polyamide (PA), Polycarbonate (PC), Cycloolefin copolymers (COC), Polyoxymethylene (POM), Acrylonitrile-butadiene-styrene (ABS), polyvinyl carbonate (PVC), ethylene tetrafluoroethylene (ETFE), polytetrafluoroethylene (PTFE), polyvinyl fluoride (PVF), polyvinylidene fluoride (PVDF) and/or ethylene-tetrafluoroethylene-hexafluoropropylene-fluoropolymer (EFEP).

3. The method according to claim 1, wherein the hard particles include organic particles, and/or inorganic particles selected from the group consisting of corundum (Al2O3), ruby, sapphire, quartz (SiO2), topaz (Al2[(F,OH)2|SiO4]), silicon carbide (SiC), diamond (C), boron nitride (BN), aggregated diamond nanorods (ADNR), ZrO2, dopants of ZrO2, sand, TiO2, metal powders, ceramic powders and inorganic agglomerates.

4. The method according to claim 1, characterized in that the belt body is made of metal, wherein the belt body is closed by welding, to form an endless ring before the coating is applied.

5. The method according to claim 4, characterized in that the belt body, which is closed to form an endless ring, is circumferentially arranged between two rollers before the coating is applied.

6. The method according to claim 1, characterized in that the base material and the hard particles are applied to an upper run of the belt body formed into a closed ring and distributed uniformly on the upper run by means of the doctor blade, wherein the belt body is moved further in a circumferential direction during or after the distribution of the base material and the hard particles.

7. The method according to claim 1, characterized in that the hard particles are mixed into the base material forming the matrix for the hard particles prior to application to the first main surface of the belt body.

8. The method according to claim 1, characterized in that the base material and the hard particles are sprayed, brushed, rolled and/or trowelled onto the first main surface.

9. The method according to claim 1, characterized in that the hard particles have a grain size of between 0.01 and 3 mm.

10. An endless belt, comprising: a belt body having a first main surface and a second main surface, wherein the first main surface and the second main surface of the belt body are connected to one another via lateral edges, wherein a coating is applied to the first main surface of the belt body being opposite to an inner side of the endless belt, wherein the coating forms an outer side of the endless belt, and the coating comprises a matrix which consists of at least one base material with hard particles of at least one material with a hardness measured according to Vickers of between 1400 [HV] and 10060 [HV] having been embedded into the base material, wherein the coating is applied directly to the first main surface of the belt body.

11. The endless belt according to claim 10, characterized in that the base material forming the matrix for the hard particles is made of at least one polymer or a mixture of polymers selected from the group of polyimide (PI), polypropylene (PP), monoaxially oriented polypropylene (MOPP), biaxially oriented polypropylene (BOPP), polyethylene (PE), polyphenylene sulfide (PPS), polyetheretherketone (PEEK) polyetherketone (PEK), polyethyleneimide (PEI), polysulfone (PSU), Polyaryletherketone (PAEK), Polyethylene naphthalate (PEN), Liquid crystalline polymers (LCP), Polyester, Polybutylene terephthalate (PBT), Polyethylene terephthalate (PET), Polyamide (PA), Polycarbonate (PC), Cycloolefin copolymers (COC), Polyoxymethylene (POM), Acrylonitrile-butadiene-styrene (ABS), polyvinyl carbonate (PVC), ethylene tetrafluoroethylene (ETFE), polytetrafluoroethylene (PTFE), polyvinyl fluoride (PVF), polyvinylidene fluoride (PVDF) and/or ethylene-tetrafluoroethylene-hexafluoropropylene-fluoropolymer (EFEP).

12. The endless belt according to claim 10, characterized in that the hard particles are organic particles, and/or inorganic particles selected from the group consisting of corundum (Al2O3), ruby, sapphire, quartz (SiO2), topaz (Al2[(F,OH)2|SiO4]), silicon carbide (SiC), diamond (C), boron nitride (BN), aggregated diamond nanorods (ADNR), ZrO2, dopants of ZrO2, sand, TiO2, metal powders, ceramic powders, and inorganic agglomerates.

13. The endless belt according to claim 10, characterized in that the hard particles have a grain size of between 0.01 and 3 mm.

14. The endless belt according to claim 10, characterized in that a surface of the coating comprises 1 to 10000 hard particles per cm².

15. The endless belt according to claim 10, characterized in that the coating has a slip resistance of R13 according to DIN-51130 in a dry and in a wet surface condition.

16. The endless belt according to claim 10, characterized in that the belt body is made of metal.

17. The endless belt according to claim 10, characterized in that the coating has a layer thickness of between 0.1 and 5 mm.

18. The endless belt according to claim 10, characterized in that the coating has an average roughness depth of more than 100 μm.

19. The endless belt according to claim 10, characterized in that the endless belt has a circumferential length of between 0.2 m and 30 m.

20. The endless belt according to claim 10, characterized in that the coating is seamless.
